(19) United States
(12) Patent Application Publication
(10) Pub. No.: US 2005/0081665 A1
(43) Pub. Date: Apr. 21, 2005

(54) Mechanical two-directional transportation apparatus

(76) Inventor: Hao-Yen Lin, Taipei Hsien (TW)

Correspondence Address: BACON & THOMAS, PLLC, 625 SLATERS LANE, FOURTH FLOOR, ALEXANDRIA, VA, 22314, US

(21) Appl. No.: 10/685,604

(22) Filed: Oct. 16, 2003

(51) Int. Cl. F16H 35/02

(52) U.S. Cl. 74/393

(57) ABSTRACT

The invention is about a mechanical two-directional transportation apparatus, specifing a mechanical two-directional transportation apparatus which makes use of a differential gearwheel construction with a changing cors, which results in the different rotation speeds of the gear-wheels creating a movement with and against the rotary motion.

### BACKGROUND OF THE INVENTION

1) Field of the Invention

The invention is about a mechanical two-directional transportation apparatus, specifying a mechanical two-directional transportation apparatus which makes use of one group of gearwheels construction with an variable rotation speed, which results in the differential speeds of the gearwheels creating a movement with and against the rotary motion.

2) Description of the Prior Art

A movement from the source gear-wheel is conveyed over the transportation gear-wheel onto an output gear-wheel installed on a second axis, thus turning it in the same speed as the source gear-wheel. A second source gear-wheel gives direct motion to the output gear-wheel and creates an inverted drive of the output gear-wheel on the second axis.

### SUMMARY OF THE INVENTION

The objective of the invention is to provide a mechanical two-directional transportation apparatus.

### BRIEF DESCRIPTION OF THE DRAWINGS

FIG. 1 is a drawing of the rotary motion with and against the rotation, through use of the differential rotation speeds.

FIG. 2 is a drawing of the rotary motion with and against the rotation.

FIG. 3 is a drawing of the differential rotation speeds.

FIG. 4 is a drawing of the changes in the differential rotation speeds.

FIG. 5 is a drawing of a specific illustration of the rotary motion with and against the rotation.

FIG. 6 is a principle of structure technology.

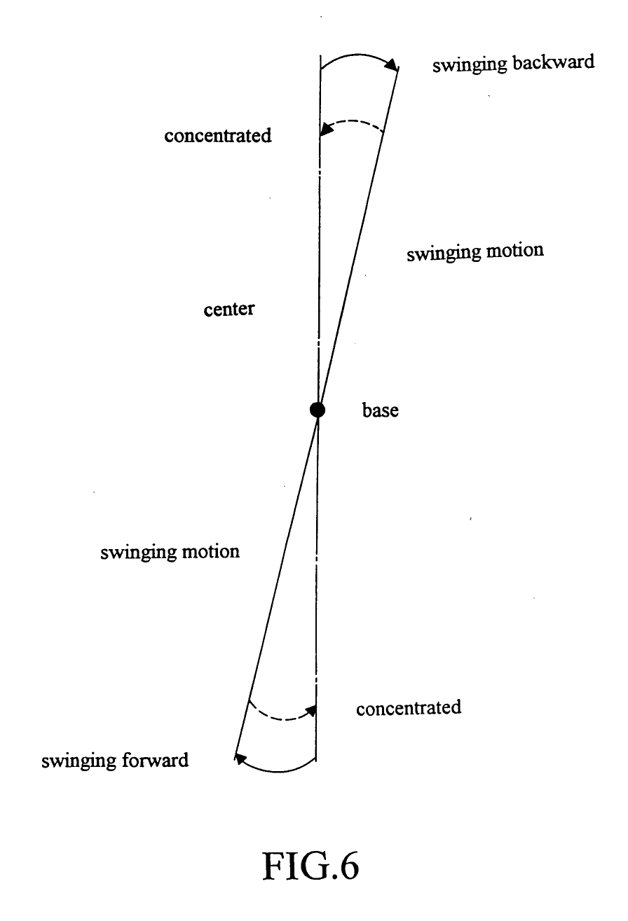

### DETAILED DESCRIPTION OF THE PREFERRED EMBODIMENT

To enable a further understanding of the objectives and the technological methods of the invention herein, the brief description of the drawings below is followed by the detailed description.

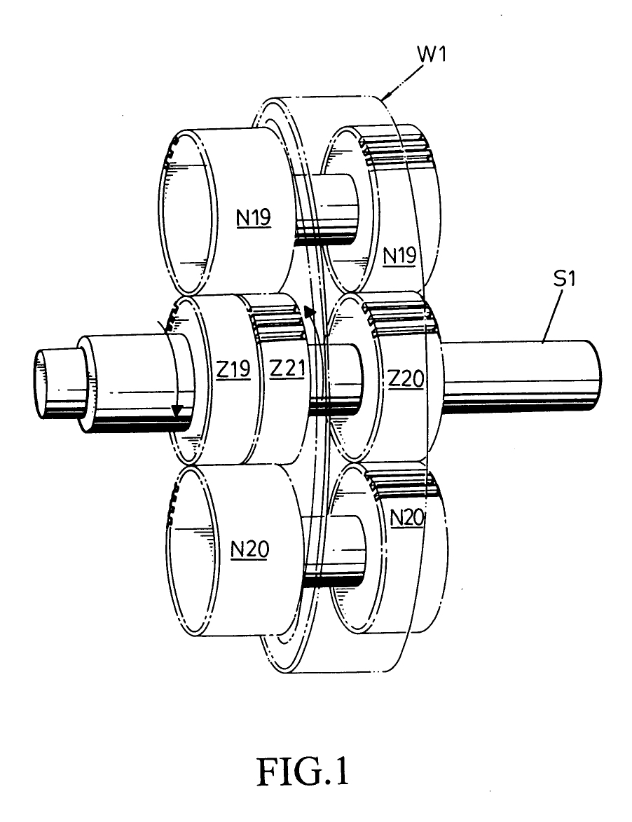

Referring to FIG. 1, the invention makes use of a construction comprising three central gear-wheels lined up on one axis. These three gearwheels are transportation gearwheels with the same diameter, but differing in the number of cogs by one. Furthermore [symbol] an flywheel is used, which has got two or more teams of satellite gearwheels those of satellite gearwheels have across engage with pitch circle of three central gearwheels. With basic cogs gearwheel from the three central gearwheels is defined as the orbit-gearwheel, this gearwheel encircled by two (or more) team of satellite gear from the outer side of the flywheel, and to make two team's satellite gearwheel create the rotation by itself, through each rotation of the satellite-gearwheels, also encircled on the pitch circle of other two central gearwheels, each cycling, under orbit gearwheel is fixed, the central gearwheel with one cog more than the orbit gearwheel is back up a distance of one cog, while another central gearwheel with one cog less than orbit gearwheel is forward a distance of one cog. Two teams of satellite gearwheel are installed on suitable position of flywheel, continue cycling to create a central gearwheel keep on backward action, meanwhile, the other central gear keep on forward action from a position of an immovable orbit-gearwheel, through the use of two turning gearwheels that apply pressure with and against the direction of the turning motion such a exercise effect provides a two-directional transport apparatus∘

Description of the Assembly

1. A flywheel is attached, with a input drive stimulation in form of a gearwheel construction attached to both ends of the surface;

2. A orbit-gearwheel with the fixed cog number Z is installed in a central position on inner side of the flywheel, it is fixed outside from whole transportation apparatus as a fixed support;

3. An output-gearwheel with same pitch circle to orbit-gearwheel but installed the one more number of cogs from orbit-gearwheel equaling Z+1, and set on a central position on top side of the flywheel;

4. Another output-gearwheel also with same pitch-circle to orbit-gearwheel but installed one less number of cogs from orbit-gearwheel equaling Z−1, and set on a central position on the top side of the flywheel, next to the above mentioned output-gearwheel;

5. One team of satellite-gearwheel with the number of installed cogs equaling N, which is installed in the 0 degree position of the flywheel, that included an input-satellite/gearwheel which engage with the pitch circle of orbit-gearwheel and the other is set on top side of flywheel and defined as a output-satellite-gearwheel to engage across pitch circle of two output gear-wheels;

6. Another team of satellite-gearwheel with the number of installed cogs may be one more or one less with fore mentioned satellite-gearwheel construction, equaling N−1 or N+1, which corresponds with same pitch circle of the fore team of satellite gear-wheel, and which is installed in the 180 degree position of the flywheel, this team also included an input-satellite-gearwheel that engage with the pitch circle of orbit-gearwheel 1 and the other of the team is set on top side of flywheel and defined as a output-satellite-gearwheel, which across engage pitch circle of two output gear-wheels;

7. Description of the Preferred Embodiment

FIG. 1, shows a drawing of the rotary motion with and against the rotation, through use of the differential rotation of two teams of satellite-gearwheel

8. Shown is one team of satellite gear-wheel N19, which has across engage with orbit-gearwheel. Z20 as well as the two of output-gearwheels Z19 [symbol] Z21, through the inner and outer side of the flywheel W1 and which has 19 cogs installed, furthermore other team of satellite-gearwheel N20, which also has engage with orbit-gearwheel Z20 as well as two output-gearwheels Z19 [symbol] Z21, through the inner and outer side of the flywheel W1 and which has 20 cogs installed, with the orbit-gearwheel Z20 fixed on the axis and connect it to the outer place of this construction as a fixed support; with each cycling of the flywheel W1, to push the output-gearwheel Z19 forward one-cog distance against the cycling-direction of the flywheel W1 and the output gear-wheel Z21 backward for one-cog distance with the cycling-direction of the flywheel W1, continue flywheel cycling then output-gearwheel Z19 keep moving forward, and output-gearwheel Z21 keep moving backward, thus to create a two-direction transmittal effect;

The output speed equals: (speed ratio)
(19÷20/19)÷[(20÷20/19)−(19÷20/19)]=19:1
(21÷20/19)÷[(20÷20/19)−(21÷20/19)]=21:1

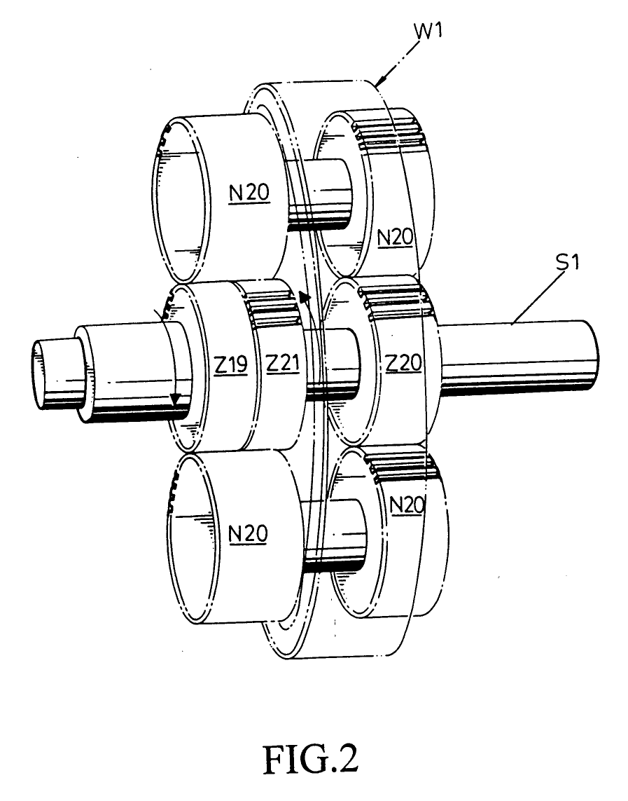

FIG. 2, shows a drawing of the rotary motion with and against the rotation.

9. Both team of satellite-gearwheels N20 possess 20 cogs and have engage with the orbit-gearwheel Z20 through the inner side of the flywheel W1. These two of satellite-gearwheels N20 also have engage with the output-gearwheels Z19 [symbol] Z21, through the top side of the flywheel W1. The orbit-gearwheel Z20 is installed on the axis S1 and connect it to outside of the construction as a fixed support with each cycling of the flywheel W1, to push the output-gearwheel Z19 forward one-cog distance against the cycling-direction of the flywheel W1 and the output gear-wheel Z21 backward for one-cog distance with the cycling-direction of the flywheel W1, continue flywheel cycling then output-gearwheel Z19 keep moving forward, and output-gearwheel Z21 keep moving backward, thus to create a two-direction transmittal effect;

The output speed equals:(speed ratio)
(19÷20)÷[(20÷20)−(19÷20)]=19:1
(21÷20)÷[20÷20)−(21÷20)]=21:1

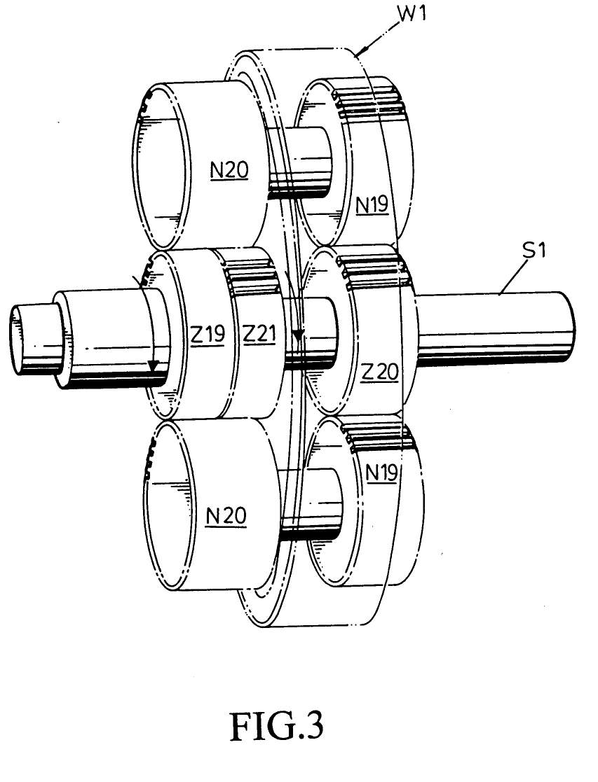

FIG. 3, shows a drawing of the varying rotation speeds.

Both satellite-gearwheels N19 possess 19 cogs and have engage with pitch circle of orbit-gearwheel Z20 through the inner side of the flywheel W1. The two satellite-gearwheels N20 with 20 cogs have engage with the output-gearwheels Z19 [symbol] Z21, through the top side of the flywheel W1. As previous statement, orbit-gearwheel Z20 is immovable as a fixed support, it has 20 cogs then transmits the cycling motion of the flywheel W1, with each cycling of the flywheel W1 pushing the output gear-wheel Z19 forward 1/9,256 part of the revolution direction of flywheel W1 and the output gear-wheel Z21 forward 1/399 part of the cycling-direction of the flywheel W1, continue flywheel cycling then output-gearwheel Z19 keep moving forward, and output-gearwheel Z21 keep moving backward with a very slow speed, thus to create a single-direction and both output-gearwheel Z19 [symbol] Z21 are divided into a differential speed transmittal effect;

The output speed equals: :(speed ratio)
(19÷20)÷[(20÷19)−(19÷20)]=9.256:1
(21÷20)÷[(20÷19)−(21÷20)]=399:1

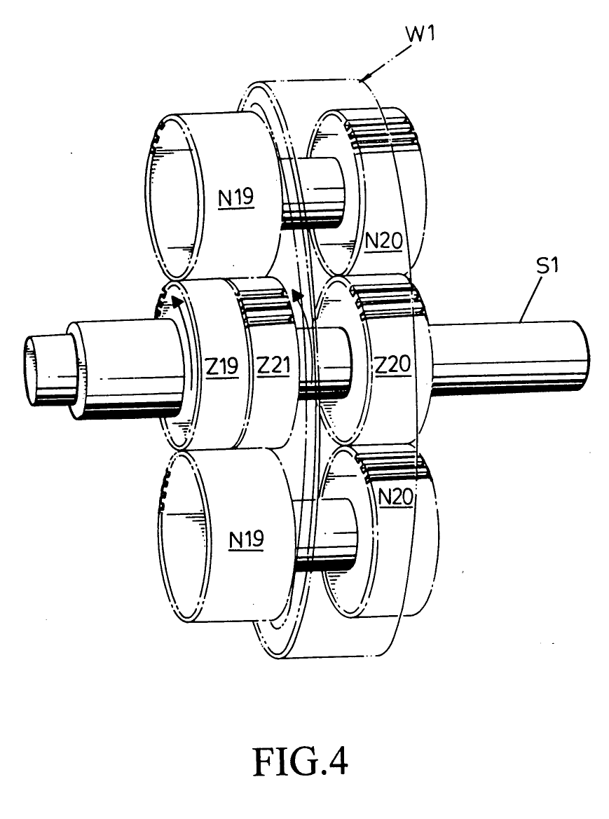

FIG. 4, shows a drawing of the changes in the varying rotation speeds.

Both satellite-gearwheels N20 have 20 cogs and have engage with the pitch circle of orbit-gearwheel Z20 through the inner side of the flywheel W1. The two satellite-gearwheels N19 with 19 cogs have across engage with the pitch circle of output-gearwheels Z19 [symbol] Z21, through the top side of the flywheel W1. As above statement orbit-gearwheel Z20 is immovable as a fixed support, and it has 20 cogs then transmits the cycling-motion of the flywheel W1, with each cycling of the flywheel W1 pushing the output-gearwheel Z19 stay on it's position for no action and the output gear-wheel Z21 backward with 1/10.5 part speed of the cycling-direction of the flywheel W1, continue cycling then output-gearwheel Z19 keep immovable, and output-gearwheel Z21 keep moving backward, thus to create a single-direction and both output-gearwheel Z19 [symbol] Z21 are engaged into a single speed transmittal effect;

The output speed equals:
(19÷20)÷[(20÷20)−(19÷19)=0
(21÷19)÷[(20÷20)−(21÷19)]=10.5:1

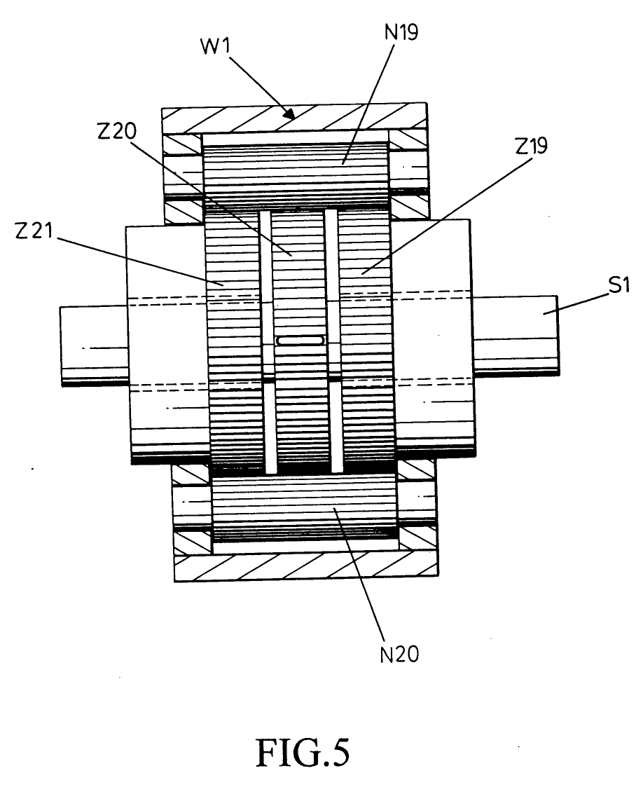

FIG. 5, shows a drawing of the specific example.

10. The orbit-gearwheel Z20 and the output-gearwheels Z19, Z21 are arranged together on one axis. The orbit-gearwheel Z20 forms the center, the output gear-wheels Z19 [symbol] Z21 are located on each side of the orbit-gearwheel Z20, both satellite-gearwheels are set apart on the 0 degree and 180 degree position of the flywheel W1, they have across engage with pitch circle of the orbit-gearwheel Z20 and the output-gearwheels Z19 [symbol] Z21, One cycling for rotation of the fly-wheel W1 to push the output-gearwheel Z19 forward one-cog distance against the cycling-direction of the flywheel W1 and the output gear-wheel Z21 backward for one-cog distance with the cycling-direction of the flywheel W1, continue flywheel cycling then output-gearwheel Z19 keep moving forward, and output-gearwheel Z21 keep moving backward, thus to create a two-direction transmittal effect;

The output speed equals (reduction ratio):
(19÷20)÷[(20÷20)−(19÷20)]=19:1
(21÷20)÷[(20÷20)−(21÷20)]=21:1

Description of the Special Characteristics

The special characteristic of the invention is, that a orbit-gearwheel is used as a fulcrum of lever, which moves a lever through the satellite-gearwheels, this results in pushing one output-gearwheel forward as one end of lever while the other output-gearwheel end is backward as another end of the lever. Thus achieved a two-directional movement through a team of differential gears action;

The second special characteristic of the invention is, that the two satellite gear-wheels installed apart on the 180 degree and 0 degree position of flywheel have one cog difference, setting up the orbit-gearwheel to be a circle orbi, the satellite-gearwheels towed a cycling as a cycloid motion from the center of orbit-gearwheel. With different number of cogs on the satellite-gearwheels but same pitch diameter it, results in a differential speed jointly to drive the output-gearwheel moving thus determining the transport ability, such a function provides the latest invention in gear-wheel transportation.

The third special characteristic of the invention is, as the above mentioned, under max modification limit of gear to change the cogs number of gears, according to the examples presented in FIG. 3 and FIG. 4, we create a change in the output speed and output direction of the two-directional transportation apparatus.

Technological Basis

A fulcrum middle on the lever, a swinging motion is exerted the lever then both ends swing, one end swings forwards, the other end swings backwards at the same time, thus creating a reciprocating motion.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A two-directional transportation apparatus, moving with and against the rotation direction, with the possibility to create movement through a differential speed, comprising a central orbit-gear wheel, an output-gear wheel with one more cog than the standard to create a movement against the rotation direction, another output gear-wheel with less cogs than the standard to create a movement with the rotation direction, these creating a transportation construction, which creates a movement with and against the rotation direction with a differential speed of both output-gear wheel which can be adjusted through the difference in the number of cogs;
furthermore comprising:
two team of satellite gear wheels with the same pitch diameter but different number of cogs, these having encircle on pitch-circle of the orbit-gear wheel, each team of satellite gear wheel to create itself rotation of differential speed and meantime to drive two output-gear wheel to create a two-directional movement;
the above mentioned two team of satellite gear-wheels, where one satellite gear-wheel has the normal number of cogs while the other satellite gearwheel has more or less cogs than the standard, with both team of satellite gearwheels installed on the 180 degree position of the flywheel and engage with pitch circle of two output gearwheels and the orbit-gear wheel, they are arranged on one axis, while flywheel is running to make both team of satellite gears to create themselves rotate motion, and two team of satellite gear wheels are encircling, they do themselves to be runed as cycloid motion, while one of output-gearwheel with less cogs than the orbit-gearwheel is being pushed forward meanwhile the other output gearwheel with more cogs than the orbit-gearwheel is being pushed backwards, thus creating a motion with and against the rotating direction by the flywheel is running continues;
therefore the complete construction comprises of a flywheel [symbol] a central axis [symbol] a orbit-gearwheel an output-gearwheel for the output in direction of the rotation [symbol] another output-gearwheel for the output against the direction of the rotation [symbol] one team of satellite-gearwheel which include a input-gear and output gear, also other satellite-gearwheel team with a different number of cogs of one input gearwheel and one output-gear.

2. According to claim 1 the two-directional transportation apparatus, wherein at least upon two teams of satellite gearwheels have engage with around on the pitch circle of the orbit gearwheel and the satellite gearwheels that create the swinging motion as cycloid works according to a self rotation to be start movement mode.

3. According to claim 1 the two-directional transportation apparatus, wherein the two teams of satellite gear-wheels installed apart in the 0 degree and 180 degree position of the flywheel each team possess a different number of cogs, with a difference of at least one cog, with the while two teams of satellite gearwheels having engage and surround with the pitch circle of orbit gear wheel, thus create two team of satellite gearwheel to be cycloid movement with differential speed rotation, while to drive two output gearwheel run rotation;
the formula to calculate the output speed is as follows:

| | | |
|---|---|---|
| Cognumber Output-Gearwheel | as | Cogs O. |
| Cognumber orbit Gearwheel | as | Cogs B |
| Cognumber Output-Satellite Gearwheel | as | Cogs T. |
| Cognumber Input Satellite Gearwheel | as | Cogs I |

(CogsO ÷ CogsT) ÷ {[CogsB ÷ (CogsI ÷ CogT)] − [CogO ÷ (CogsI ÷ CogsT)]} = i (output speed ratio)

4. According to claim 1 the two-directional transportation apparatus, wherein one output gear-wheel creates a movement against the rotation direction of the driving wheel, therefore having a number of 1 cog less than the number of cogs of the orbit gear wheel, with the reduction of the number of cogs having a variation effect on the output speed.

5. According to claim 1 the two-directional transportation apparatus, wherein one output gear-wheel creates a movement with the rotation direction of the encircling wheel, therefore having a number of cogs more than the number of cogs of the guiding gear-wheel, with the increase of the number of cogs having a variation effect on the output speed.

6. According to claim 1 the two-directional transportation apparatus, each team of satellite gear wheel may be composed of one input satellite gear wheel and another output satellite gear wheel, wherein input satellite gearwheel to engage with pitch circle of orbit gearwheel, and output satellite gearwheel o engage with pitch circle of output gearwheel,

7. According to claim 1 the two-directional transportation apparatus, wherein the input satellite gearwheel engage with pitch circle of orbit gearwheel has the normal number of cogs, therefore output satellite gear-wheels engage with pitch circle of output gearwheels have to have a number of cogs at least one cog less or more than the standard, thus influencing the output speed of the output gearwheel;
the formula to calculate the output speed is as follows:

| | | |
|---|---|---|
| Cognumber Output-Gearwheel | as | Cogs O. |
| Cognumber orbit Gearwheel | as | Cogs B |
| Cognumber Output-Satellite Gearwheel | as | Cogs T. |
| Cognumber Input Satellite Gearwheel | as | Cogs I |

(CogsO ÷ CogsT) ÷ [(CogsB ÷ CogsI) − (CogO ÷ CogsT)] = i (output speed ratio)

8. According to claim 1 the two-directional transportation apparatus, the apparatus is composed of at least two team of satellite-gearwheels or more for construction.
